(19) United States
(12) Patent Application Publication
(10) Pub. No.: US 2022/0234162 A1
(43) Pub. Date: Jul. 28, 2022

(54) HONING APPARATUS

(71) Applicant: Gehring Technologies GmbH + Co. KG, Ostfildern (DE)

(72) Inventors: Theodor Hüttner, Notzingen (DE); Martin Freitag, Nürtingen (DE); Oliver Bey, Ostfildern (DE); Ralf Denzinger, Wendlingen (DE); Denis Isba, Metzingen (DE)

(73) Assignee: Gehring Technologies GmbH + Co. KG, Ostfildern (DE)

(21) Appl. No.: 17/611,783

(22) PCT Filed: Mar. 19, 2020
(86) PCT No.: PCT/EP2020/057568

§ 371 Date: Nov. 16, 2021

(30) Foreign Application Priority Data
May 17, 2019 (DE) 10 2019 113 032.8

(51) Int. Cl. B24B 33/02; B23Q 3/157; B23Q 39/02; B24B 27/00

(52) U.S. Cl. CPC B24B 33/022; B23Q 3/157; B24B 27/0076; B24B 27/0023; B23Q 39/028

(57) ABSTRACT

The invention relates to an apparatus for honing a bore in a workpiece, having an apparatus base, having a turntable arranged on the apparatus base, with a plurality of workpiece receptacles, having at least one loading station for loading and unloading from the workpiece receptacles, having at least one honing station with a horizontal honing unit and with a displacement device for displacing the horizontal honing unit relative to the turntable, and having at least one tool magazine for receiving a plurality of honing spindles.

### CROSS REFERENCE TO RELATED APPLICATIONS

This is a National Stage Application filed under 35 U.S.C. 371 based on International Patent Application No. PCT/EP2020/057568, filed on Mar. 19, 2020, which claims priority to German Patent Application 10 2019 113 032.8 filed May 17, 2019. The entire disclosures of each of the foregoing are hereby incorporated herein by reference in their entireties.

### BACKGROUND

The present invention relates to an apparatus for honing a bore in a workpiece.

Apparatuses of this kind are known from the prior art and are used in particular for honing crank bores and camshaft bores in crankcases.

Honing often requires multiple honing operations using different honing tools. For example, a first honing operation can be used to correct the diameter and dimensional accuracy of a bore and the second honing operation can be used to smooth or otherwise topographically process the surface, e.g. so as to have an intended (for example high or differently defined) roughness. For this purpose, apparatuses of the type mentioned at the outset generally have a tool changing device for changing the honing tools in an in particular automated manner. The tool changing device typically comprises a tool magazine for receiving a plurality of honing tools, it being possible to displace the tool magazine relative to a honing unit such that the tool magazine can approach the honing unit in order to replace a honing tool. It is possible for a gripping unit comprising a gripping arm to be provided, which feeds the honing tool from the honing unit to the tool magazine or vice versa. The known solutions have a complex structure, which generally leads to high manufacturing costs and increased effort required to put the apparatus into operation.

DE 10 2016 201 456 A1 and DE 20 2016 002857 U1 each disclose an apparatus having the features of the preamble of claim 1.

### SUMMARY OF THE INVENTION

The problem addressed by the present invention is that of simplifying a tool change in an apparatus of the type mentioned at the outset. In particular, it is desirable for the apparatus to have a structurally simple and inexpensive design.

This problem is solved according to the invention by an apparatus.

The apparatus according to the invention is used for honing a bore in a workpiece. In particular, the apparatus according to the invention is an apparatus for honing a crank bore in a crankcase. In the context of the invention, a crank bore is understood to mean in particular the bore in a crankcase that is used to support a crankshaft in the crankcase.

The apparatus comprises an apparatus base which, as seen in a viewing direction orthogonal to the apparatus base, is preferably rectangular. In particular, a longitudinal extension and a transverse extension of the apparatus base are dimensioned such that the apparatus can be transported on conventional means of transport, in particular on a truck, which makes it easier to transport the apparatus to a destination.

The apparatus also comprises a turntable arranged on the apparatus base. In particular, the turntable is designed as a lifting turntable. The turntable can be rotated about a vertical turntable axis and has a plurality of workpiece receptacles. The workpiece receptacles are arranged such that a workpiece received in a workpiece receptacle can be transported to different work stations of the apparatus by a rotary movement of the turntable about the turntable axis.

The workpiece receptacles are preferably arranged so as to be offset from one another along a circumference around the turntable axis. In particular, four workpiece receptacles are provided which are arranged so as to be offset from one another at an angle of 90°. It is also advantageous for the workpiece receptacles to be arranged at in particular the same radial distance from the turntable axis.

The apparatus also comprises at least one loading station for loading and unloading the workpiece receptacles, the at least one loading station forming a work station of the apparatus. Loading and unloading the workpiece receptacles is understood to mean in particular the workpiece receptacles being loaded with workpieces and the workpieces being removed from the workpiece receptacles.

The apparatus also comprises a honing station having a horizontal honing unit and having a displacement device for displacing the horizontal honing unit relative to the turntable. The at least one honing station forms a further work station of the apparatus. A honing spindle which has a honing tool comprising honing stones is coupled or couplable to the horizontal honing unit such that the honing spindle can be rotated about a horizontal spindle axis and can be moved back and forth in a direction parallel to the spindle axis. In this respect, translational and rotational relative movements between the workpiece and the honing tool can be superimposed, which superimposition is characteristic of a honing process. The apparatus preferably comprises a spindle drive for driving a rotational movement of the honing spindle about the spindle axis. The back and forth movement of the honing spindle is preferably provided by the horizontal honing unit being displaced by means of the displacement device.

The apparatus also comprises a tool magazine for receiving a plurality of honing spindles. Honing spindles comprising differently designed honing tools can therefore be kept available for different honing operations. For an automated tool change, i.e. automated replacement of a honing spindle coupled to the horizontal honing unit, it is also preferred when the honing spindles each have an interface for automatic change, for example an HSK interface. This can reduce the time required for a tool change, which has a positive effect on productivity.

The at least one tool magazine is fixed in an immovable manner relative to the device base, at least with respect to translational movements. In this respect, the at least one tool magazine is fixed such that at least translational movements of the at least one tool magazine are not possible. In other words, the tool magazine does not have any translational degrees of freedom, but in this regard is attached such that it is rigid with respect to the apparatus base. The honing tools received in the tool magazine are in this case held in a fixed and predetermined position in the fixed tool magazine.

The at least one tool magazine is positioned or positionable with respect to the at least one honing station such that the at least one tool magazine takes up a tool-changing position in which relative movements between the at least one tool magazine and the horizontal honing unit of the at least one honing station, which movements are required for a tool change—in order to place a honing tool in the at least one tool magazine and/or in order to receive a honing tool from the tool magazine—can be provided by displacement movements of the horizontal honing unit by means of the displacement device. In this respect, a tool change can take place with the tool magazine fixed. It is therefore not necessary to provide the at least one tool magazine with an additional displacement device (for example NC axes) in order to make an automated tool change possible.

An apparatus according to the invention is structurally simple and inexpensive (with no additional displacement device for displacing the at least one tool magazine). Furthermore, an apparatus according to the invention is characterized by comparatively fast operational readiness, since a process in which such a displacement device for displacing the at least one tool magazine is set up (for example calibrating the NC axes) can be omitted. In an apparatus according to the invention, the effort required for maintenance is also reduced, since fewer moving components are present by comparison with the apparatuses known from the prior art.

The at least one tool magazine is expediently positioned in the tool-changing position such that a longitudinal axis of a honing tool received in the tool magazine is aligned substantially parallel to the spindle axis of the horizontal honing unit. This allows a particularly simple and quick tool change, since the honing tools in the tool magazine already have the same orientation as in a state coupled to the horizontal honing unit. It is accordingly no longer necessary to pivot the magazine which is in any case translationally fixed. In this respect, in particular no tilting or pivoting movement of the horizontal honing unit is required in order to pick up or put down a honing tool. The honing tools are preferably arranged in the tool magazine so as to be one above the other in the vertical direction, which promotes a particularly space-saving arrangement in a horizontal plane.

In principle, it is possible for the at least one tool magazine to be fixed in an immovable manner with respect to the apparatus base, i.e. for both translational movements and rotational movements of the at least one tool magazine to not be possible. In other words, the tool magazine is arranged such that it is completely rigid with respect to the apparatus base. The at least one tool magazine can, however, be connected to the apparatus base via a pivot joint, a pivot axis of the pivot joint being oriented such that the at least one tool magazine can be pivoted between the tool-changing position and a maintenance position, the at least one tool magazine being positioned, when in the maintenance position, at least partially outside the apparatus base as seen in a viewing direction orthogonal to the apparatus base (in plan view). The maintenance position thus allows free access to the honing tools received in the at least one tool magazine, so that the honing tools can be replaced in a convenient manner. The pivot axis can be oriented horizontally. However, it is preferred when the pivot axis is oriented vertically.

It is also preferred when the horizontal honing unit can be displaced in three spatial directions by means of the displacement direction. The displacement device preferably comprises three NC axes, which are in particular oriented orthogonally to one another. A first spatial direction is aligned parallel to the spindle axis, and the other two spatial directions extend orthogonally to one another and span a plane which is oriented orthogonally to the spindle axis or first spatial direction. As a result, a position of the horizontal honing unit, in particular a position of a honing tool coupled to the horizontal honing unit, can be easily adapted to an exact position of a bore in a workpiece that is to be machined. In this respect, the apparatus can be set up particularly quickly. In particular, any center deviations between the honing tool and the bore can be easily corrected, which promotes precise machining. In addition, an embodiment of this kind makes it possible to machine different types of workpiece (which have different bore positions) using the same apparatus, in particular without the need for manual set up. For this purpose, it is conceivable, for example, for the spatial coordinates of a bore to be machined to be part of a data record that is stored in a control device of the apparatus for the machining of a particular workpiece. By being able to displace the horizontal honing unit by means of the displacement direction, the horizontal honing unit can also easily approach the tool magazine.

The workpiece receptacles can be arranged in relation to the turntable such that a bore axis of a bore in a workpiece received in a workpiece receptacle, which bore is provided for being honed by the horizontal honing unit, is oriented substantially tangentially to the turntable. In the context of the invention, “oriented substantially tangentially to the turntable” means “oriented substantially tangentially to the circular path on which the workpiece receptacles of the turntable are moved during the rotary movement about the turntable axis.” In this respect, the workpiece receptacles are positioned in such a way that a vertical plane containing the bore axis does not contain the turntable axis of the turntable. The workpiece receptacles are preferably arranged on the turntable via one or more arms, in particular such that the workpiece receptacles are arranged so as to be radially spaced from the turntable, in particular at the same radial distances. This promotes free access to the bore for honing.

It is also possible for the horizontal honing unit to be positioned or positionable with respect to the turntable such that the spindle axis is oriented substantially tangentially to the turntable, i.e. substantially tangential to the circular path on which the workpiece receptacles of the turntable are moved during the rotary movement. This allows the apparatus to be constructed in a particularly compact manner, since the horizontal honing unit can be arranged almost “next to” the turntable.

In the context of an alternative possible embodiment, the workpiece receptacles are arranged in relation to the turntable such that a bore axis of a bore in a workpiece received in a workpiece receptacle, which bore is provided for being honed by the horizontal honing unit, is oriented substantially radially to the turntable axis. In this respect, the workpiece receptacles are positioned in such a way that a vertical plane containing the bore axis contains the turntable axis of the turntable. The horizontal honing unit is in this case preferably positioned such that the spindle axis is oriented substantially radially to the turntable axis. A radial arrangement of the workpiece receptacles makes it possible to additionally provide at least one vertical honing unit for honing cylinder bores in a crankcase, it being possible for the at least one vertical honing unit to be fastened to one or more carriages above the turntable and in this case operate two workpiece receptacles.

In particular, the apparatus has at least one first measuring station comprising at least one first measuring unit for measuring cylinder bores in a crankcase, the at least one first measuring station forming at least one work station of the apparatus. The at least one first measuring unit is used in particular to remeasure cylinder bores which, for example, have previously been honed on a separate honing machine. The at least one first measuring unit preferably comprises at least one measuring spindle which can be inserted into a bore to be measured and has a measuring head for measuring the bore (for example with regard to diameter, dimensional accuracy, surface roughness, etc.). The at least one first measuring unit is in particular arranged such that the at least one measuring spindle extends substantially vertically. The cylinder bores can then be measured without the need for the position of the workpiece to be changed between the at least one honing station and the at least one first measuring station.

It is also possible for the apparatus to have at least one second measuring station comprising at least one second measuring unit, the at least one second measuring unit being designed to measure the bore that is provided for being honed by the horizontal honing unit (e.g. with regard to diameter, dimensional accuracy, surface roughness, etc.). The at least one second measuring station forms a further work station of the apparatus. In particular, the at least one second measuring unit is a measuring unit for measuring a crank bore in a crankcase.

The at least one second measuring unit can comprise at least one measuring spindle which can be inserted into the bore to be measured and has a measuring head for measuring the bore. It is also possible for the at least one second measuring station to have a displacement device for displacing the at least one second measuring unit relative to the turntable, in particular in three spatial directions. It is also advantageous for the at least one second measuring unit to be positioned or positionable such that a longitudinal extension of the at least one second measuring unit, in particular a longitudinal extension of the at least one measuring spindle, is oriented substantially tangentially to the turntable. The crank bore can then be measured without the need for the position of the workpiece to be changed between the honing station and the second measuring station.

At least one measuring spindle magazine for receiving a plurality of measuring spindles for the at least one second measuring unit is preferably arranged on the at least one second measuring station. This makes it possible to have measuring spindles comprising differently designed measuring heads available for different measuring operations. The at least one measuring spindle magazine is preferably positioned or positionable such that a longitudinal axis of a measuring spindle received in the measuring spindle magazine is oriented substantially tangentially to the turntable.

It is also preferred when the at least one loading station has at least one loading unit for loading and unloading the workpiece receptacles. This can make loading and unloading the workpiece receptacles easier. The loading unit can be operated manually. However, it is preferred when the loading unit can be operated by machine. The workpiece receptacles can then be loaded and unloaded in an automated manner. The at least one loading unit can be, for example, a portal robot (gantry robot), a roller conveyor, a robot or the like. In particular, the workpiece receptacles are directly loaded from above.

In principle, each functional unit (horizontal honing unit, loading unit, optionally first measuring unit, optionally second measuring unit) can have its own base (machine bed). These individual parts can then be connected to form an apparatus base. However, it is preferred when the at least one horizontal honing unit and/or the at least one first measuring unit and/or the at least one second measuring unit and/or the at least one loading unit is/are arranged on the apparatus base, the apparatus base being formed as one piece. In particular, all of the functional units are arranged on the one-piece apparatus base. The apparatus base thus forms a common base for all of the functional units. An arrangement of this kind is particularly stable, and therefore relative positions between the functional units can be established and maintained particularly precisely. In addition, it allows the apparatus to have a particularly compact design. In particular, an arrangement of this kind makes it possible for the apparatus to be transported to a destination as a pre-assembled structural unit on conventional means of transport (for example trucks). In addition, the time required for on-site start up can be reduced, since there is no need to assemble and align the functional units on-site.

The apparatus preferably has at least one switch cabinet (for example for accommodating electronic devices such as control devices, safety devices, power supply devices, etc.), and this at least one switch cabinet is arranged on the apparatus base. It is particularly preferred when the at least one switch cabinet is rigidly connected to the apparatus base. A structure of this kind is particularly compact. In addition, the time required to assemble and put the apparatus into operation can be reduced, since there is no need for the time-consuming laying of cables between the apparatus and a switch cabinet that is provided separately, in particular spatially separated, from the apparatus. The at least one switch cabinet preferably at least partially forms a housing wall of an apparatus housing which defines the work stations.

It is also preferred when at least one workpiece monitoring device is provided for monitoring the size and/or position and/or alignment of a bore of a workpiece to be honed. A workpiece monitoring device of this kind comprises at least one workpiece monitoring element which is arranged on a particular residential tool and is designed, when the honing tool is inserted into the bore, to check whether the bore in the workpiece has a sufficient bore width and/or to check for a positioning or alignment error of the bore in the workpiece. Ways of designing the workpiece monitoring device can be similar or identical to the solutions described in WO 2019/020779 A1—the disclosure of which is incorporated into the present description by reference.

### BRIEF DESCRIPTION OF THE DRAWINGS

Further features, possible applications and advantages of the invention can be found in the following description of embodiments of the invention, which are explained with reference to the drawings; the features may be essential for the invention both alone and in different combinations, without being explicitly referred to again. In the drawings:

FIG. 1 is a sketched illustration of an embodiment of an apparatus according to the invention in a first perspective view;

FIG. 2 is a sketched illustration of the apparatus from FIG. 1 in a second perspective view; and

FIG. 3 is a simplified sketched illustration of the apparatus from FIG. 1 in a plan view.

### DETAILED DESCRIPTION

In the following figures, corresponding components and elements have the same reference signs. For the sake of clarity, not all of the reference signs are shown in all of the figures.

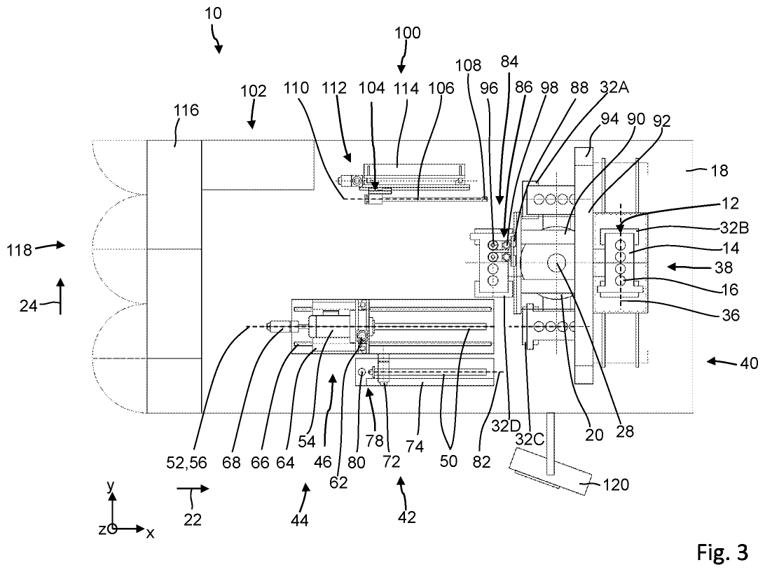

In the figures, an apparatus is shown which is designated as a whole by the reference sign 10. The apparatus 10 is used for honing a bore 12 in a workpiece 14; in the present example, the workpiece 14 is formed by a crankcase 14 and the bore 12 is formed by a crank bore 12 in the crankcase 14 (cf. FIG. 3). The crankcase 14 is designed as an engine block, for example, and, in addition to the crank bore 12, has four cylinder bores 16 oriented orthogonally to the crank bore 12 (cf. FIG. 3).

In the figures, a coordinate system is also shown, which has axes (X, Y, Z) orthogonal to one another.

The apparatus 10 comprises an apparatus base 18 which, as seen in a viewing direction orthogonally to the apparatus base 18, is by way of example and preferably substantially rectangular (cf. FIG. 3). An extension of the apparatus base 18 along a longitudinal axis (in the figures along the X-axis) is greater than an extension of the apparatus base XX along a transverse axis (in the figures along the Y-axis).

The apparatus 10 also comprises a turntable 20 which is arranged, as seen in a longitudinal direction 22 (in the figures in the X-direction), approximately in the front third and, as seen in a transverse direction 24 (in the figures in the Y-direction), approximately centrally on the apparatus base 18. The turntable 20 can be rotated, by means of a rotary drive 26 arranged below the turntable 20, about a vertical turntable axis 28 parallel to the Z-axis of the coordinate system shown. By way of example and preferably, the turntable 20 is designed as a lifting turntable which can be displaced along the turntable axis 28 by means of a lifting drive 30.

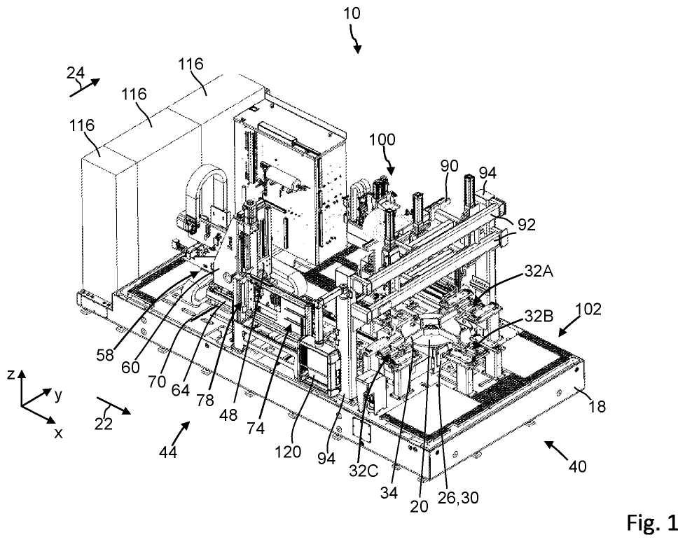

Four workpiece receptacles 32A, 32B, 32C, 32D are arranged on the turntable 20, each for receiving a workpiece 14. The workpiece receptacles 32A, 32B, 32C, 32D are arranged so as to be offset from one another at an angle of 90° along a circumference around the turntable axis 28 (cf. FIG. 3). In the present example, the workpiece receptacles 32A, 32B, 32C, 32D are each fastened to the top of the turntable 20 via an arm 34 and are arranged so as to be radially spaced apart from the turntable 20 at the same distances (cf. FIG. 1).

In the embodiment of the apparatus 10 shown in the figures, the workpiece receptacles 32A, 32B, 32C, 32D are arranged in relation to the turntable 20 such that a bore axis 36 of the crank bore 12 of a crankcase 14 received in a workpiece receptacle 32A, 32B, 32C, 32D is aligned substantially tangentially to the circular path on which the workpiece receptacles 32A, 32B, 32C, 32D of the turntable 20 are moved during a rotary movement of the turntable 20 about the turntable axis 28 (cf. FIG. 3).

In embodiments which are not shown, it is also possible for the workpiece receptacles 32A, 32B, 32C, 32D to be arranged in relation to the turntable 20 such that a bore axis 36 of the crank bore 12 of a crankcase 14 received in a workpiece receptacle 32A, 32B, 32C, 32D is aligned substantially radially to the circular path on which the workpiece receptacles of the turntable are moved during a rotary movement of the turntable 20 about the turntable axis 28.

The turntable 20 is used as a transfer unit within the apparatus 10 and makes it possible for a workpiece 14 received in a workpiece receptacle 32A, 32B, 32C, 32D to be transported to different work stations of the apparatus 10 by a rotary movement of the turntable 20 about the turntable axis 28. In the present example, with four workpiece receptacles 32A, 32B, 32C, 32D offset from one another at an angle of 90°, a total of four work stations can be approached by workpieces 14 at the same time.

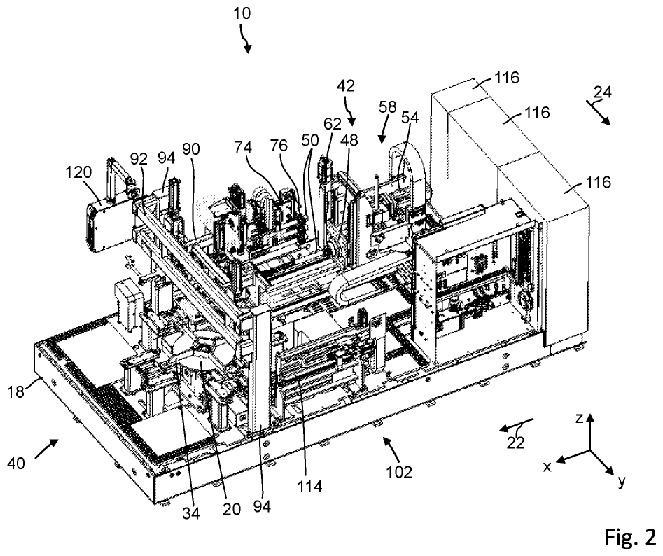

A first work station is formed by a loading station 38 for loading and unloading the workpiece receptacles 32A, 32B, 32C, 32D. The loading station 38 is arranged in the region of the transverse side 40 of the apparatus base 18, which transverse side is at the front in the longitudinal direction 22. The loading station 38 preferably has a motor-driven loading unit (not shown), for example in the form of a portal robot. As can be seen from FIGS. 1 and 2, a workpiece receptacle 32A, 32B, 32C, 32D is accessible from above in the loading station 38, so that the workpiece receptacles 32A, 32B, 32C, 32D can be loaded or unloaded from above (in the figures in the Z-direction).

By rotating the turntable 20 by 90° clockwise, a workpiece 14 received in a tool receptacle 32A, 32B, 32C, 32D can be transported from the loading station 38 to a honing station 42. The honing station 42 is arranged in the region of a first longitudinal side 44 of the apparatus base 18 and forms a second work station of the apparatus 10.

The honing station 42 has a horizontal honing unit 46 for honing the crank bore 12 of the crankcase 14. The horizontal honing unit 46 comprises a spindle box 48 to which a honing tool 50 comprising honing stones is detachably coupled in a manner known per se (cf. FIG. 2). The honing tool 50 is mounted on the spindle box 48 so as to be rotatable about a horizontal spindle axis 52. A spindle drive 54 is provided to drive a rotary movement of the honing tool 50 about the spindle axis 52.

As can be seen from FIG. 3, the horizontal honing unit 46 is positioned with respect to the turntable 20 such that the spindle axis 52, or a longitudinal axis 56 of a honing tool 50 coupled to the horizontal honing unit 46, is oriented substantially tangentially to the turntable 20. In this respect, the spindle axis 52 or the longitudinal axis 56 is aligned parallel to the bore axis 36 of the crank bore 12 of a crankcase 14 received in a workpiece receptacle 32A, 32B, 32C, 32D when the crankcase 14 is in the honing station 42 (in FIG. 3 in the workpiece receptacle 32C).

In order to displace the horizontal honing unit 46 relative to the turntable 20 or relative to a workpiece 14 received in a workpiece receptacle 32A, 32B, 32C, 32D, the apparatus 10 also has a displacement device 58.

As can be seen from FIG. 1, the spindle box 48 is mounted on a support 60 so as to be displaceable along a vertical axis (in the figures along the Z-axis). A motor 62 is provided for driving a displacement movement of the spindle box 48 along the vertical axis.

The support 60 is mounted on a carriage 64 so as to be displaceable along the longitudinal axis of the apparatus 10 (in the figures along the X-axis). For this purpose, two mutually parallel guide rails 66 are mounted on the carriage 64, on which guide rails the support 60 runs (cf. FIG. 3). A motor 68 is provided for driving a displacement movement of the support 60 along the longitudinal axis. A displacement movement of the support 60 along the longitudinal axis causes, in particular, a movement of the honing tool 50 into the bore 12 to be honed and the back and forth movement of the honing tool 50 that is characteristic of the honing process.

The carriage 64 is in turn mounted on the apparatus base 18 so as to be displaceable along the transverse axis (in the figures along the Y-axis). For this purpose, guide rails 70 are mounted on the apparatus base 18, on which guide rails the carriage 64 runs (cf. FIG. 1). A motor 72 is also provided for driving a displacement movement of the carriage 64 along the transverse axis.

The apparatus 10 also has a tool magazine 74 for receiving a plurality of honing tools 50. The tool magazine 74 has a plurality of honing tool receptacles 76 for receiving one honing tool 50 each (cf. FIG. 2). The honing tool receptacles 76 are preferably arranged in the tool magazine 74 so as to be one above the other in the vertical direction.

In the present example, the tool magazine 74 is arranged adjacent to the horizontal honing unit 46 in the region of the longitudinal side 44 of the apparatus base 18. The tool magazine 74 is connected to the apparatus base 18 via a pivot joint 78, a pivot axis 80 of the pivot joint 78 preferably being oriented vertically. The tool magazine 74 can be pivoted between a tool-changing position (shown in the figures) and a maintenance position (not shown) in which the tool magazine 74 is pivoted, starting from the tool-changing position shown for example in FIG. 3, clockwise, preferably by approximately 90°, about the pivot axis 80. Translational movements of the tool magazine 74 are blocked, however.

In the tool-changing position (cf. FIG. 3), the tool magazine 74 is positioned such that the relative movements between the tool magazine 74 and the horizontal honing unit 46, which movements are required for a tool change, can be provided by displacement movements of the horizontal honing unit 46 by means of the displacement device 58. In order to replace a honing tool 50, the horizontal honing unit 46 can, for example, approach a honing tool receptacle 76 and place a honing tool 50 in the honing tool receptacle 76 and/or pick up a honing tool 50 from the honing tool receptacle 76. In the tool-changing position, the tool magazine 74 is positioned such that a longitudinal axis 82 of a honing tool 50 received in a honing tool receptacle 76 is oriented substantially parallel to the spindle axis 52 (cf. FIG. 3).

In the maintenance position, the tool magazine 74 is positioned such that the tool magazine 74 is positioned at least partially outside the apparatus base 18 as seen in a viewing direction orthogonal to the apparatus base 18. This allows free access to the honing tool receptacles 76, so that honing tools 50 received in the honing tool receptacles 76 can be replaced easily.

Starting from the honing station 42, a workpiece 14 received in a workpiece receptacle 32A, 32B, 32C, 32D can be transported to a first measuring station 84, which forms a third work station of the apparatus 10, by a further rotation of the turntable 20 by 90° clockwise.

The first measuring station 84 has a first measuring unit 86 for measuring the cylinder bores 16 in the crankcase 14. The first measuring unit 86 is held on a carriage 88 which is mounted on an arm 90 of a transverse support 92 so as to be displaceable along the transverse axis (in the figures along the Y-axis). The transverse support 92 is held on two support columns 94 at a vertical distance above the turntable 20 and overlaps the turntable 20 in the transverse direction 24. In this respect, the first measuring unit 86 is held at a vertical distance above the turntable 20.

The first measuring unit 86 has two measuring spindles 96, each comprising a measuring head, for measuring the cylinder bores 16. The measuring spindles 96 of the first measuring unit 86 extend substantially vertically. In order to insert a measuring spindle 96 into a cylinder bore 16, each measuring spindle 96 can be displaced along a vertical axis (in the figures along the Z-axis) by means of a motor 98. By displacing the first measuring unit 86 along the transverse axis, cylinder bores 16 arranged next to one another can be approached one after the other.

Starting from the first measuring station 84, a workpiece 14 received in a tool receptacle 32A, 32B, 32C, 32D can be transported to a second measuring station 100, which forms a fourth work station of the apparatus 10, by a further rotation of the turntable 20 by 90° clockwise.

In the present example, the second measuring station 100 is arranged in the region of the longitudinal side 102 of the apparatus base 18 opposite the honing station 42 and has a second measuring unit 104 for measuring the bore 12 (crank bore 12) provided for being honed by the horizontal honing unit 46.

The second measuring unit 104 has one or more measuring spindles 106 which each comprise a measuring head 108, the second measuring unit 104 being positioned such that a longitudinal axis 110 of a particular measuring spindle 106 is oriented substantially tangentially to the turntable 20 (cf. FIG. 3). In this respect, the longitudinal axis 110 of a particular measuring spindle 106 is aligned parallel to the bore axis 36 of the crank bore 12 of the crankcase 14 when the crankcase 14 is in the second measuring station 100 (in FIG. 3 in the workpiece receptacle 32A).

The second measuring unit 104 can be displaced in three spatial directions by means of a displacement device 112. The displacement device 112 preferably comprises three NC axes oriented orthogonally to one another, a first axis being aligned parallel to the longitudinal axis 110 of the measuring spindle 106 and being used to insert the measuring spindle 106 into a bore 12 to be measured. The two other axes span a plane which is oriented orthogonally to the longitudinal axis 110 of the measuring spindle 106 and are used to align the measuring spindle 106 relative to a position of the bore 12.

A measuring spindle magazine 114 for receiving a plurality of measuring spindles 106 is also provided at the second measuring station 100. The measuring spindle magazine 114 is arranged and positioned on the apparatus base 18 such that relative movements between the second measuring unit 104 and the measuring spindle magazine 114, which movements are required for a measuring spindle change, can be provided by displacement movements of the second measuring unit 104 by means of the displacement device 112 (cf. FIG. 3). The measuring spindle magazine 114 is positioned such that a longitudinal axis of a measuring spindle 106 received in the measuring spindle magazine 114 is aligned substantially tangentially to the turntable 20 (cf. FIG. 3).

The apparatus 10 also comprises a plurality of switch cabinets 116 for accommodating electronic devices (for example control devices, safety devices, power supply devices, etc.). In the present example, the switch cabinets 116 are arranged on the transverse side 118 of the apparatus base 18 opposite the loading station 38 and are rigidly connected to the apparatus base 18. The switch cabinets 116 preferably partially form the wall of an apparatus housing (not shown) which defines the work stations.

The apparatus 10 also comprises an operating unit 120 in the form of an operating terminal for operating the apparatus 10.

1. Apparatus for honing a bore in a workpiece, which bore is aligned horizontally during machining for honing a crank bore in a crankcase, comprising:
an apparatus base;
a turntable which is arranged on the apparatus base and has a plurality of workpiece receptacles, the turntable being rotatable about a vertical turntable axis and the workpiece receptacles being arranged such that a workpiece received in a workpiece receptacle can be transported to different work stations of the apparatus by a rotary movement of the turntable about the turntable axis;
at least one loading station for loading and unloading the workpiece receptacles, the at least one loading station forming a work station of the apparatus;
at least one honing station having a horizontal honing unit and having a displacement device for displacing the horizontal honing unit relative to the turntable, the at least one honing station forming a work station of the apparatus, and a honing tool comprising cutting means being coupled or couplable to the horizontal honing unit such that the honing tool can be rotated about a horizontal spindle axis and moved back and forth in a direction parallel to the spindle axis;
at least one tool magazine for receiving a plurality of honing tools; characterized in that
the at least one tool magazine is fixed in an immovable manner at least with respect to translational movements, the at least one tool magazine being positioned or positionable with respect to the at least one honing station such that the at least one tool magazine assumes a tool-changing position in which relative movements between the at least one tool magazine and the horizontal honing unit of the at least one honing station, which movements are required for a tool change, in order to place a honing tool in the at least one tool magazine and/or in order to receive a honing tool from the tool magazine, can be provided by displacement movements of the horizontal honing unit by means of a displacement device.

2. Apparatus according to claim 1, characterized in that the at least one tool magazine is positioned in the tool-changing position such that a longitudinal axis of a honing tool received in the tool magazine is aligned substantially parallel to the spindle axis of the horizontal honing unit.

3. Apparatus according to claim 1, characterized in that the at least one tool magazine is connected to the apparatus base via a pivot joint, a pivot axis of the pivot joint being oriented such that the at least one tool magazine can be pivoted between the tool-changing position and a maintenance position, the at least one tool magazine being positioned, when in the maintenance position, at least partially outside the apparatus base as seen in a viewing direction orthogonal to the apparatus base.

4. Apparatus according to claim 1, characterized in that the horizontal honing unit can be displaced in three spatial directions by means of the displacement device.

5. Apparatus according to claim 1, characterized in that the workpiece receptacles are arranged with respect to the turntable such that a bore axis of a bore in a workpiece received in a workpiece receptacle, which bore is provided for being honed by the horizontal honing unit.

6. Apparatus according to claim 1, characterized in that the workpiece receptacles are arranged with respect to the turntable such that a bore axis of a bore in a workpiece received in a workpiece receptacle, which bore is provided for being honed by the horizontal honing unit.

7. Apparatus according to claim 1, characterized in that the apparatus has at least one first measuring station comprising at least one first measuring unit for measuring cylinder bores in a crankcase, the at least one first measuring station forming at least one work station of the apparatus.

8. Apparatus according to claim 1, characterized in that the apparatus has at least one second measuring station comprising at least one second measuring unit for measuring the bore, the at least one second measuring station forming at least one work station of the apparatus.

9. Apparatus according to claim 1, characterized in that the at least one loading station has at least one loading unit for loading and unloading the workpiece receptacles.

10. Apparatus according to claim 1, characterized in that the at least one horizontal honing unit and/or the at least one first measuring unit and/or the at least one second measuring unit and/or the at least one loading unit, and the at least one first measuring unit and the at least one second measuring unit and the at least one loading and unloading unit, is/are arranged on the apparatus base.

11. Apparatus according to claim 1, characterized in that the apparatus has at least one switch cabinet, the at least one switch cabinet being arranged on the apparatus base.

12. Apparatus according to claim 1, characterized in that at least one workpiece monitoring device is provided for monitoring the size and/or position and/or alignment of a bore of a workpiece to be honed, the at least one workpiece monitoring device comprising at least one workpiece monitoring element arranged on a particular honing tool, which workpiece monitoring element is designed, when the honing tool is inserted into the bore, to check whether the bore in the workpiece has a sufficient bore width and/or to check for a positioning or alignment error of the bore in the workpiece.
